(19) United States
(12) Patent Application Publication
(10) Pub. No.: US 2009/0245095 A1
(43) Pub. Date: Oct. 1, 2009

(54) Voice Over Internet Protocol Clarity During Degradation

(75) Inventors: Martinianus BudiTjahja Hadinata, Brunnen (SZ); Charles Steven Lingafelt, Durham, NC (US); John Elbert Moore, Jr., Brownsburg, IN (US); Brian Marshall O'Connell, Cary, NC (US); Keith Raymond Walker, Austin, TX (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/060,447

(22) Filed: Apr. 1, 2008

(51) Int. Cl. H04L 12/26

(52) U.S. Cl. 370/216

(57) ABSTRACT

Illustrative embodiments provide a computer implemented method, a data processing system and a computer program product for improving voice over Internet Protocol clarity during degradation. In one illustrative embodiment, the computer implemented method comprises monitoring a call, determining whether degradation exists; and responsive to a determination that degradation exists, applying a corrective action. The computer implemented method further comprises determining whether a quality of the call has improved and responsive to determining that the quality of the call has improved, further monitoring the call to form a monitored quality. The computer implemented method further comprises, determining whether monitored quality is acceptable, and responsive to determining monitored quality acceptable, removing the corrective action.

### BACKGROUND OF THE INVENTION

1. Field of the Invention

The present invention relates generally to an improved data processing system and more specifically to a computer implemented method, an apparatus and a computer program product for improving voice over Internet Protocol clarity during degradation.

2. Background Description

With voice over Internet Protocol (IP) telephony service connection quality may typically be reduced during a call due to periodic or sustained network bandwidth constraints and latency issues. For example, a reduction in connection quality maybe exhibited in a call as intermittent breaks in the signal affecting the sound heard, or reduced volume of sound due to a low signal strength or a call having background noise or even cross talk when you here another unrelated call coming through on the channel. Current manually implemented solutions include disconnecting the call and re-trying the call again at a later time or using an alternate telephony technology, such as a land line or a cell phone. Current automated solutions to this problem include detecting the occurrence of such a degradation and responding to the degradation by increasing the compression of the call. When compression is increased more data is typically lost when using a lossy compression technique. Lossy compression is a technique used to reduce the size or amount of data being transmitted and does not allow the original data to be restored after compression. Lossy compression typically provides the most quality for the least data. Increasing the compression used during the call reduces the network bandwidth requirements of the call. At some point the increase in compression may cause too great a reduction in the original content of the data and reduces the audio fidelity and therefore the clarity of the call.

### BRIEF SUMMARY OF THE INVENTION

Illustrative embodiments provide a computer implemented method, a data processing system and a computer program product for improving voice over Internet Protocol clarity during degradation. In one illustrative embodiment, the computer implemented method monitors a call, determining whether degradation exists; and responsive to a determination that degradation exists, applies a corrective action. The computer implemented method further determines whether a quality of the call has improved and responsive to determining that the quality of the call has improved, further monitors the call to form a monitored quality. The computer implemented method further determines whether the monitored quality is acceptable; and responsive to determining the monitored quality acceptable, removes the corrective action.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of components of a call management service in accordance with illustrative embodiments;

FIG. 4 is a tabular view of a degradation method correspondence in accordance with illustrative embodiments;

FIG. 5 is a flowchart of a manual process using the call management service of FIG. 3, accordance with illustrative embodiments; and

FIG. 6 is a flowchart of an automated process using the call management service of FIG. 3, accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

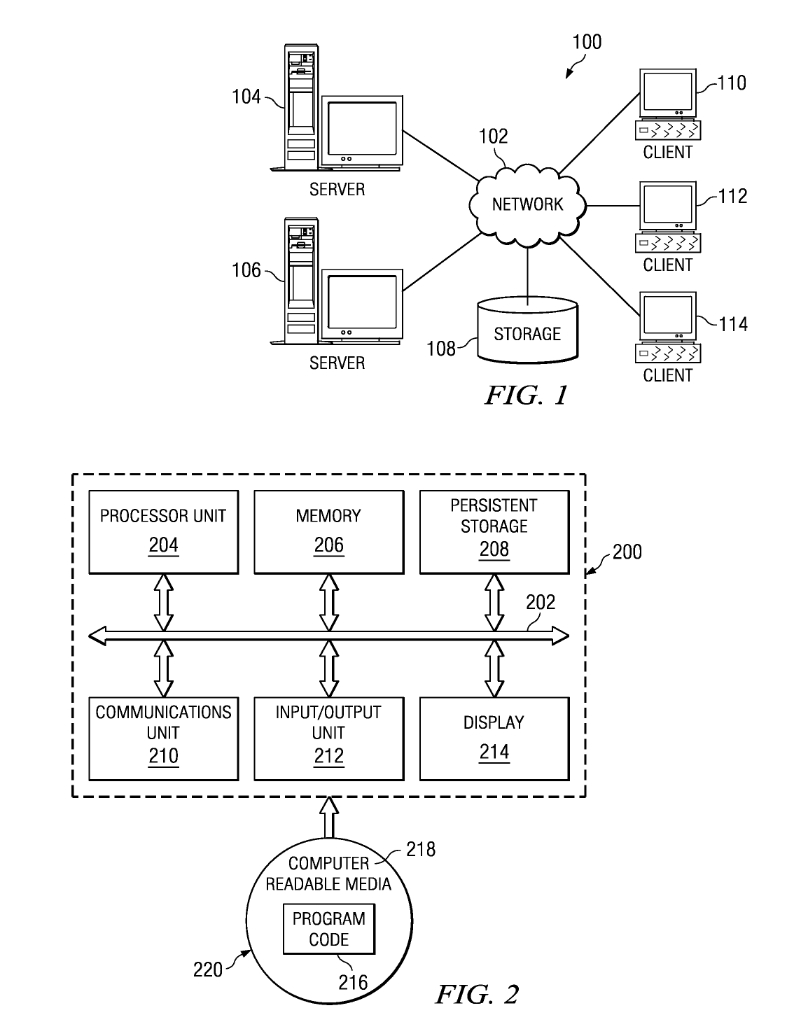

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Illustrative embodiments provide a capability to improve a Voice over Internet Protocol (VoIP) communication system after the system has detected a degradation of Voice over Internet Protocol call quality. The provided capability comprising altering the normal information transmission methods to include additional methods of changing rate, and/or tone, and/or volume of the speech, and improving error correction algorithms, that diminish impairments in the transmission system. The additional methods maybe invoked automatically by predetermined rules and thresholds of the Voice over Internet Protocol system or by a selection of actionable items comprising corrective actions, by the user.

For example, in an illustrative embodiment, a user on client 110 experiences degradation of a Voice over Internet Protocol call using network 102 and Voice over Internet Protocol communication system on server 106 detects the degradation. Methods of changing rate, and/or tone and/or volume of the speech, and improving error correction algorithms may be selected from a location on server 106, or another server 104, to be invoked automatically by predetermined rules and thresholds of the Voice over Internet Protocol system. In an alternative, a selection of actionable items may be made by the user on client 110 through network 102. In either case, corrective actions are performed as a means to improve the call quality. Call monitoring continues to determine if the change applied resulted in improved call quality. If the call quality is acceptable the applied change may be removed.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices and may comprise a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

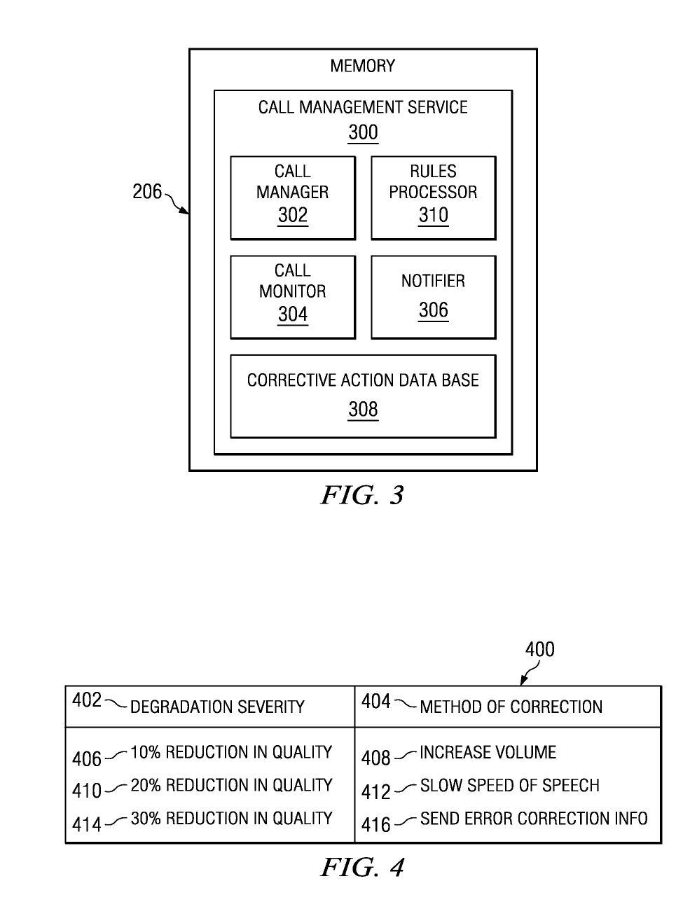

With reference to FIG. 3, a block diagram of components of a call management service 300 in accordance with illustrative embodiments is shown. Components of call management service 300 are shown within memory 206 of system 200 of FIG. 2. Component may be located within memory 206 for execution while located in other storage locations of system 200, such as persistent storage 208 until needed, as is known in the art. Call management service 300 relies on components of system 200 in operation, but these components will not be addressed. In this example, components of the call management service 300 comprise call manager 302, call monitor 304, notifier 306, corrective action database 308 and rules processor 310.

Call manager 302 provides a capability of managing and coordinating the other components of call management service 300. Call manager 302 typically provides a common interface to the components such as those used when administering the components or servicing the components.

Call monitor 304 provides a capability to monitor the attributes of a call in progress on the network. Monitoring allows the service to determine if a call is meeting service requirements. In particular through monitoring of the call the service may identify calls requiring corrective action.

Notifier 306 provides a capability to notify a caller or other process in the event service requirements of the call are not being met. Notifier 306 may provide notification in the form of a message or other system acceptable method. The notification may be a request to perform an action, a message to create awareness of a situation or potential situation, or to present a set of options. Further, a notification may initiate an action in the case of an automated process.

Corrective action database 308 comprises a set of methods that may be called upon in the event of service degradation of a call. Corrective actions comprise methods that may be used to adjust the services of the system in support of the calls. For example, a corrective action may be in the form of a rule specifying a condition and a resulting action to be invoked when the condition is met. The action may be a procedure to be executed that adjusts an aspect of the call environment. The database in this case could contain the set of instructions to be executed as well as the controls to determine if and when the instructions should be invoked. In this manner there is provided a set of actions to resolve particular problems related to a call service. The set comprises one or more possible actions for one or more possible call problems related to degradation.

Rules processor 310 provides a capability to interpret and execute the rules as found within corrective action database 308. A rules processor may be implemented using a scripting language or other programming technique.

The components just described may be combined to form other combinations or split into smaller functional elements while still providing the described service. For example a corrective action database may be encompassed within an existing database or file system while still providing the same capability. In another example the call manager may include both a call monitor and a notifier functions. While the packaging may differ the function provided remains the same. Other embodiments may have added functions while still providing the functions just described. For example, another embodiment may add a billing function that charges for corrective actions taken during a call.

With reference to FIG. 4, a tabular view of a degradation method correspondence in accordance with illustrative embodiments is shown. In the example shown, the tabular view illustrates in a simple manner a correspondence of a condition and an action provided as a possible solution. For example, table 400 is shown having two columns. A first column 402 is labeled degradation severity, while a second column 404 is labeled method of correction. Column 402 further contains entries such as 406 indicating “10 percent reduction in quality.” A corresponding entry in column 404 contains an entry 408 indicating “increase volume.” In a similar manner entry 410 indicates “20 percent reduction in quality.” A corresponding entry in column 404 contains an entry 412 indicating “slow speed of speech.” In a similar manner entry 414 indicates “30 percent reduction in quality.” A corresponding entry in column 404 contains an entry 416 indicating “send error correction info.” In this example, column 402 indicates a condition while column 404 indicates an action to perform as a result. The method of correction, or action, may be an executable component or a reference to an executable component. In a similar manner entries may be organized by other attributes of problems such as problem type, error number and the like to enable systematic selection and application of a corrective action.

Using the simple example further, rules processor 310 may search the table given a request to resolve a degradation of 10 percent and perform the action noted. Other examples may be performed that involve conditional processing as well in accordance with the problem and the specification of the rule.

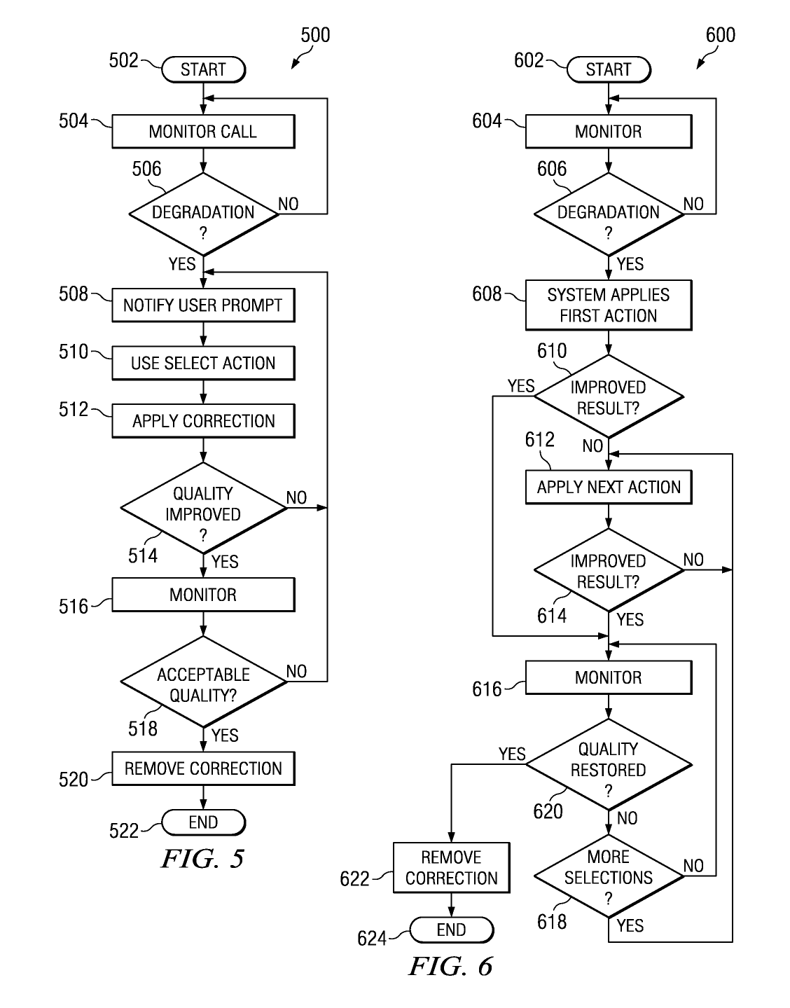

With reference to FIG. 5, a flowchart of a manual process using the call management service of FIG. 3, accordance with illustrative embodiments is shown. Process 500 is an example of a manually controlled invocation of the call management services 300 of FIG. 3.

Process 500 starts (step 502) and monitors the call (step 504). A determination is made as to whether degradation is evident (step 506). When no degradation is evident for the call a “no’ results. If degradation is found, a “yes” results. If a “no” result is obtained in step 506, process 500 loops back to step 504 and continues to monitor the call. If a “yes” is obtained in step 506, the user is notified and prompted with a set of corrective actions (step 508).

The user selects a corrective action from the set of corrective actions in the prompt (step 510). A selected action is then applied to the call system for the respective call (step 512). A determination is made as to whether the application of the corrective action resulted in improved quality for the call (step 514). If there was no improvement, a “no” results otherwise quality improved and a “yes” results. If a “no” was obtained in step 514, process 500 loops to step 508 to notify the user and prompt again.

If the result of step 514 was “yes” the monitoring of the call begins (step 516). A determination is then made as to whether acceptable quality exists (step 518). If quality is now acceptable, a “yes” results, otherwise a “no” results. If a “no” was obtained in step 518, process 500 loops back to step 508 to notify and prompt the user.

If a “yes” was obtained in step 518, a corrective action that was applied is removed (step 520) and process 500 terminates thereafter (step 522).

With reference to FIG. 6, a flowchart of an automated process using the call management service of FIG. 3, in accordance with illustrative embodiments is shown. Process 600 is an example of an automated invocation of the call management services 300 of FIG. 3.

Process 600 starts (step 602) and monitors the call (step 604). A determination is made as to whether degradation is evident (step 606). When no degradation is evident for the call a “no’ results. If degradation is found, a “yes” results. If a “no” result is obtained in step 606, process 600 loops back to step 604 and continues to monitor the call. If a “yes” is obtained in step 606, the system systematically applies a first corrective action of a set of corrective actions (step 608). The system has a capability to systematically select a corrective action from the set of corrective actions in a predefined sequence or in accordance with predefined logic applicable to the problem to be resolved. Systematic selection follows the predefined sequence as in the case of an ordered set of actions in the corrective actions database or logic provided and processed by the rules processor.

A determination is made as to whether the application of the corrective action provided an improved result (step 610). If there was no improvement, a “no” results otherwise quality improved and a “yes” results. If a “no” was obtained in step 610, a next corrective action is applied (step 612). A determination is made as to whether the application of the corrective action provided an improved result (step 614). If there was no improvement, a “no” results otherwise quality improved and a “yes” results. If a “no” was obtained in step 614, process 600 loops back and a next corrective action is applied (step 612).

If the result of step 610 was “yes” process 600 skips to step 616. Monitoring again is performed (step 616). A determination is then made as to whether quality has been restored to an original level (step 620). If quality is now acceptable, a “yes” results, otherwise a “no” results. If a “no” was obtained in step 620, a determination is made as to whether there are more selections of corrective actions to be made (step 618). If more selections exist, a “yes” results, otherwise a “no” results. If a “no” was obtained in step 618, process 600 loops back to monitor again (step 616). If a “yes” was obtained in step 618, process 600 loops back to step 612 to apply a next corrective action. If a “yes” was obtained in step 620 the previously applied corrective action is removed (step 622) and process 600 terminates thereafter (step 624).

Illustrative embodiments provide a capability to improve the quality of degraded Voice over Internet Protocol calls via a plurality of iterative automated or systematic and user selectable techniques or corrective actions. A set of corrective actions may comprise one or more corrective actions. A set of corrective actions typically comprising; sound pattern modification, packet duplication, transmission of parity information and modification of analog to digital conversion algorithms, is available. In a first example, sound pattern modification may be accomplished by one or more of: a) decrease transmission rate, where slowing speech solves problems when a voice is “cutting out” by providing increased duration of syllables, b) amplify volume, in cases where call degradation may result in a decrease in volume and a need for a louder voice, and c) apply an equalization filter, such as to remove bass and enhance treble, in cases where call degradation often entails lower frequencies to be magnified and higher frequencies to be reduced.

In another example, packet duplication may be used when all or some data packets containing voice data may be sent multiple times when it is discovered that some packets are being dropped. In yet another example, transmission of parity information for packet reconstruction may be useful when packets are arriving out of sequence. In another example, when modification of analog to digital conversion algorithm is helpful. In this case one algorithm may perform better in quiet environments, while another method may perform better in environments with additional ambient noise.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for improving voice over Internet Protocol clarity during degradation, the computer implemented method comprising:
monitoring a call;
determining whether degradation exists;
responsive to a determination that degradation exists, applying a corrective action;
determining whether a quality of the call has improved;
responsive to a determination that the quality of the call has improved, further monitoring the call to form a monitored quality;
determining whether monitored quality is acceptable; and
responsive to a determination that monitored quality is acceptable, removing the corrective action.

2. The computer implemented method for improving voice over Internet Protocol clarity during degradation of claim 1, wherein responsive to the determination that degradation exists, applying the corrective action, further comprises:
notifying a user by a prompt comprising a set of corrective actions;
receiving a selected corrective action from the set of corrective actions;
applying the selected corrective action.

3. The computer implemented method for improving voice over Internet Protocol clarity during degradation of claim 1, wherein removing the corrective action further comprises:
removing the selected corrective action.

4. The computer implemented method for improving voice over Internet Protocol clarity during degradation of claim 1, wherein responsive to the determination that the degradation exists, applying the corrective action further comprises:
systematically applying a first corrective action from a set of corrective actions.

5. The computer implemented method for improving voice over Internet Protocol clarity during degradation of claim 1, wherein determining whether monitored quality improved further comprises:
responsive to a determination that the monitored quality did not improve, systematically applying a next corrective action; and
responsive to applying the next corrective action, determining whether monitored quality improved; and
responsive to a determination that the monitored quality did not improve in response to applying the next corrective action, systematically applying a subsequent corrective action.

6. The computer implemented method for improving voice over Internet Protocol clarity during degradation of claim 1, wherein responsive to determining whether monitored quality is acceptable further comprises:
responsive to a determination that monitored quality is acceptable, removing the corrective action;
responsive to a determination that monitored quality is not acceptable, determining whether there are more corrective actions.

7. The computer implemented method for improving voice over Internet Protocol clarity during degradation of claim 6, wherein responsive to determining whether there are more corrective actions further comprises:
responsive to a determination that there are more corrective actions, applying the next corrective action; and
responsive to a determination that there are no more corrective actions, monitoring the call.

8. A data processing system for improving voice over Internet Protocol clarity during degradation, the data processing system comprising:
a bus;
a memory connected to the bus, the memory comprising computer executable instructions;
a communications unit connected to the bus;
a display connected to the bus;
a persistent storage connected to the bus; and
a processor unit connected to the bus, wherein the processor unit executes the computer executable instructions directing the data processing system to:
monitor a call;
determine whether degradation exists;
responsive to determining degradation exists, apply a corrective action;
determine whether a quality of the call has improved;
responsive to a determination that the quality of the call has improved, further monitor the call to form a monitored quality;
determine whether monitored quality is acceptable; and
responsive to a determination that monitored quality acceptable, remove the corrective action.

9. The data processing system for improving voice over Internet Protocol clarity during degradation of claim 8, wherein responsive to a determination that degradation exists, applying a corrective action, further comprises, the processor unit executes the computer executable instructions directing the data processing system to:
notify a user by prompt comprising a set of corrective actions;
receive a selected corrective action from the set of corrective actions;
apply the selected corrective action.

10. The data processing system for improving voice over Internet Protocol clarity during degradation of claim 8, wherein removing the corrective action further comprises the processor unit executes the computer executable instructions directing the data processing system to:
remove the selected corrective action.

11. The data processing system for improving voice over Internet Protocol clarity during degradation of claim 8, wherein responsive to a determination that degradation exists, applying a corrective action further comprises the processor unit executes the computer executable instructions directing the data processing system to:
systematically apply a first corrective action from a set of corrective actions.

12. The data processing system for improving voice over Internet Protocol clarity during degradation of claim 8, wherein determining whether monitored quality improved further comprises the processor unit executes the computer executable instructions directing the data processing system to:
responsive to a determination that monitored quality did not improve, systematically apply a next corrective action; and
responsive to applying the next corrective action, determine whether monitored quality improved; and
responsive to a determination that the monitored quality did not improve, systematically apply a subsequent corrective action.

13. The data processing system for improving voice over Internet Protocol clarity during degradation of claim 8, wherein responsive to determining whether monitored quality is acceptable further comprises the processor unit executes the computer executable instructions directing the data processing system to:
responsive to determining monitored quality acceptable, remove the corrective action; and
responsive to determining monitored quality not acceptable, determine whether there are more corrective actions.

14. The data processing system for improving voice over Internet Protocol clarity during degradation of claim 13, wherein determining whether there are more corrective actions further comprises, the processor unit executes the computer executable instructions directing the data processing system to:
responsive to determining there are more corrective actions, apply the next corrective action; and
responsive to determining there are no more corrective actions, monitoring the call.

15. A computer program product for improving voice over Internet Protocol clarity during degradation, the computer program product comprising:
a computer-readable medium tangibly embodying computer executable instructions thereon, the computer executable instructions comprising:
computer executable instructions for monitoring a call;
computer executable instructions for determining whether degradation exists;
computer executable instructions responsive to determining degradation exists, for applying a corrective action;
computer executable instructions for determining whether a quality of the call has improved;
computer executable instructions responsive to a determination that the quality of the call has improved, for further monitoring the call to form a monitored quality;
computer executable instructions for determining whether the monitored quality is acceptable; and
computer executable instructions responsive to determining the monitored quality acceptable, for removing the corrective action.

16. The computer program product for improving voice over Internet Protocol clarity during degradation of claim 15, wherein computer executable instructions responsive to determining degradation exists, for applying a corrective action, further comprises:
computer executable instructions for notifying a user by prompt comprising a set of corrective actions;
computer executable instructions for receiving a selected corrective action from the set of corrective actions;
computer executable instructions for applying the selected corrective action.

17. The computer program product for improving voice over Internet Protocol clarity during degradation of claim 15, wherein computer executable instructions for removing the corrective action further comprises:
computer executable instructions for removing the selected corrective action.

18. The computer program product for improving voice over Internet Protocol clarity during degradation of claim 15, wherein computer executable instructions responsive to determining degradation exists, for applying a corrective action further comprises:
computer executable instructions for systematically applying a first corrective action from a set of corrective actions.

19. The computer program product for improving voice over Internet Protocol clarity during degradation of claim 15, wherein computer executable instructions responsive to determining whether monitored quality improved further comprises:
computer executable instructions responsive to a determination that monitored quality did not improve, for systematically applying a next corrective action; and
computer executable instructions for determining whether quality improved; and
computer executable instructions responsive to a determination that monitored quality did not improve, systematically applying a subsequent corrective action.

20. The computer program product for improving voice over Internet Protocol clarity during degradation of claim 15, wherein computer executable instructions responsive to determining whether monitored quality is acceptable further comprises:
computer executable instructions responsive to determining monitored quality acceptable, for removing the corrective action;
computer executable instructions responsive to determining monitored quality not acceptable, for determining whether there are more corrective actions;
computer executable instructions responsive to determining there are more corrective actions, for applying the next corrective action; and
computer executable instructions responsive to determining there are no more corrective actions, for monitoring the call.
